(19) United States
(12) Patent Application Publication
(10) Pub. No.: US 2004/0028380 A1
(43) Pub. Date: Feb. 12, 2004

(54) Video recording/reproducing apparatus and recording media registration information display method

(76) Inventor: Ju-yup Lee, Seongnam-city (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/630,711

(22) Filed: Jul. 31, 2003

(30) Foreign Application Priority Data
Aug. 8, 2002 (KR) 2002-46948

(51) Int. Cl. H04N 5/783

(52) U.S. Cl. 386/68; 386/81; 386/82

(57) ABSTRACT

Disclosed is a video recording/reproducing apparatus and recording media registration information display method. The video recording/reproducing apparatus has a main control part that, if a signal requesting a display of a registration information guide screen for a recording media on reproduction through an interface from an external input device is received, processes the recording media registration information guide screen to be displayed on a display device, makes semitransparent an area displaying recording media registration information corresponding to the items classified on the registration information guide screen so that the semitransparent area is overlapped and displayed with images on reproduction, and, if a selection signal for a classified item is received, makes opaque the area displaying the recording media registration information corresponding to the selected item, so that the images are not seen. Therefore, registration information on a recording media on reproduction is processed for display in a set display format according to the classified items, emphasis displays are available for a selected item of the classified items, and images from the recording media on reproduction can be checked during the display of registration information on the recording media on reproduction, so that the user's convenience can be enhanced.

### PRIORITY

This application claims priority under 35 U.S.C. § 119 to an application entitled “Video Recording/Reproducing Apparatus and Recording Medium Registration Information Display Method” filed in the Korean Intellectual Property Office on Aug. 8, 2002 and assigned Serial No. 2002-46948, the contents of which are incorporated herein by reference.

### BACKGROUND OF THE INVENTION

1. Field of the Invention

The present invention relates to a video recording/reproducing apparatus and a menu display method therefor, and more particularly to a video recording/reproducing apparatus capable of providing guide screens for recording media registration information according to user's requests during reproduction of a video signal recorded on a record media.

2. Description of the Prior Art

Video recording and reproducing apparatus capable of recording and reproducing an externally received broadcast signal on a recording media, have expanded their functions in diverse ways with the development of digitization of broadcast signals and compression technologies.

Currently available video recording/reproducing apparatus are being developed which adopt all the functions of DVD players capable of reproducing video signals recorded on recording media, such as DVDs and hard disks DVD other mass storage devices such as (digital video disk or digital versatile disk), is a video recording media capable of storing high-quality movies.

Currently available video recording/reproducing apparatus are being developed to support the use of diverse video sources, such as satellite broadcasts, cable broadcasts, network broadcasts through the internet, and so on.

The video recording/reproducing apparatus described above provide menus screens in order for the functions to be easily perceived and conveniently used.. Users can operate a remote control device such as a remote controller to select a desired function from a menu list on the menu screen with right, left, up, and down cursor keys, which enables the user to conveniently select all the functions.

However, the image recording/reproducing apparatus described above has a deficiency in that, if a menu screen is displayed by a user's selection on the screen of a display device during the displaying of recorded images recorded on a recording media, the displaying images are not seen. Further, the image recording/reproducing apparatus does not provide a function capable of displaying a selected menu in an emphasized format in order for a user to easily recognize the selected menu from a displayed menu list.

### SUMMARY OF THE INVENTION

An object of the present invention is to substantially solve at least the above problems and/or disadvantages and to provide at least the advantages described below. Accordingly, it is an object of the present invention to provide a method for displaying registration information pertaining to recorded programs stored on a recording medium used in a video recording/reproducing apparatus, comprising receiving a request signal from an external access device requesting registration information pertaining to the recorded programs stored on the recording medium, providing the requested registration information pertaining to the recorded programs stored on the recording medium to a screen associated with the video recording/reproducing apparatus and displaying the requested registration information on the screen associated with the video recording/reproducing apparatus in an area on the display, the area on the display being divided into a first and second area, wherein the first area displays classifications of registration information, and the second area displays registration information of the classification of registration information, the second area being semitransparent and overlapping a displayed video signal.

It is a further object of the invention to provide an apparatus for displaying registration information pertaining to recorded programs stored on a recording medium used in a video recording/reproducing apparatus, comprising an external access device to provide a request for registration information pertaining to the recorded programs stored on the recording medium to the video recording/reproducing apparatus, a display associated with the video recording/reproducing apparatus to display requested registration information pertaining to the recorded programs stored on the recording medium, as well as recorded programs stored on the recording medium, and an area on the display to display the requested registration information pertaining to the recorded programs stored on the recording medium, the area being divided into a first and second area, wherein the first area displays classifications of registration information, and the second area displays registration information of the classification of registration information, the second area being semitransparent and overlapping a displayed video signal.

### BRIEF DESCRIPTION OF THE DRAWINGS

The above object and other features of the present invention will become more apparent by describing in detail an embodiment thereof with reference to the attached drawings, in which:

FIG. 1 is a view showing a display system of a video recording/reproducing apparatus according to an embodiment of the present invention;

FIG. 2 is a block diagram for the video recording/reproducing apparatus of FIG. 1;

FIG. 3 is a plan view of a remote controller of FIG. 1;

FIG. 4 is a view showing an illustrative initial recording media registration information guide screen displayed on a display device when a display key of FIG. 3 is selected;

FIG. 5 is a view showing another illustrative initial recording media registration information guide screen displayed on a display device when a display key of FIG. 3 is selected;

FIG. 6 is a view showing a recording media registration information guide screen displayed when any of the classified items of the recording media registration information guide screen of FIG. 5 are selected;

FIG. 7 is a view showing a recording media registration information guide screen displayed when any of the classified items of the recording media registration information guide screen of FIG. 5 are selected; and

FIG. 8 is a flow chart for showing a recording media registration information display method of a video recording/reproducing apparatus according to an embodiment of the present invention.

### DESCRIPTION OF THE PREFERRED EMBODIMENT

Hereinafter, an embodiment of the present invention will be described in detail with reference to the accompanying drawings.

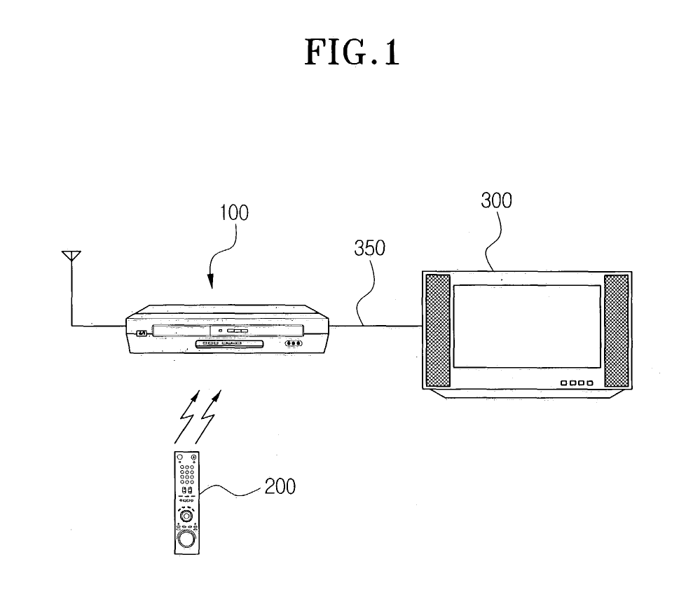

FIG. 1 is a view schematically showing a display system of a video recording/reproducing apparatus according to an embodiment of the present invention.

Referring to FIG. 1, a video recording/reproducing apparatus 100 is connected to a television set 300 through a transmission cable 350.

The video recording/reproducing apparatus 100 processes a signal received from a remote controller 200 which is an external input device, and transmits display information to the television set 300. The external input device can be the remote controller 200 transmitting a wireless signal such as infrared rays as well as other input device such as wire-type keyboards.

The video recording/reproducing apparatus 100 can be built to receive at least one or more video signals provided from a plurality of video sources. For example, the video,source may be devices which can transmit signals, such as incoming lines for ground wave television broadcasts, satellite broadcasts, and cable broadcasts, computer lines, or modem lines. The embodiment of the present invention described below encompasses video recording/reproducing apparatus built to receive at least one or more video signals from video sources such as cables, satellite dishes, local cables, digital broadcast sources (DBSs), general antennas, internet, other computer sources, camcorders, disc players, settop boxes, and so on.

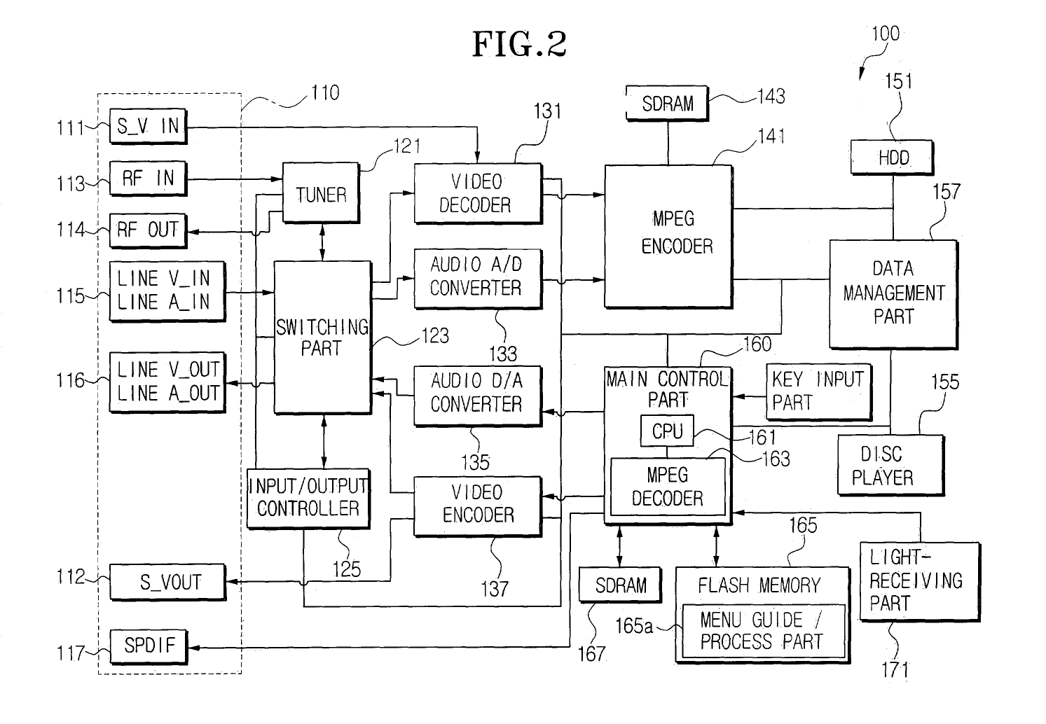

FIG. 2 is a block diagram showing a video recording/reproducing apparatus according to an embodiment of the present invention.

Referring to FIG. 2, the video recording/reproducing apparatus 100 has an input/output port 110, a tuner 121, a switching part 123, an input/output controller 125, an MPEG encoder 141, a hard disk driver (HDD) 151, a disc player 155, and a main control part 160.

The input/output port 110 can receive signals reproduced from diverse video signal sources, and also output the received signals or signals reproduced from the hard disk driver 151 (which is employed as a mass storage device).

The input/output port 110 is provided with a super video input port (S_V IN) 111, a super video output port (S_Vout) 112, an RF input port (RF IN) 113, an RF output port (RF OUT) 114, a line video/audio input port (LINED V_IN, LINE A_IN) 115, a line video/audio output port (LINE V_OUT, LINE A_OUT) 116, and a serial parallel digital interface (SPDIF) 117.

The input and output ports will now be discussed in greater detail, and will especially include information regarding ports having different input and output relationships but identical signal formats.

The super video input port 111 is a port for receiving a luminance signal Y and chrominance signals Cr and Cb in the digital format which are separated from each other, and used in connection with a digital camcorder, a DVD player, a settop box, and other similar devices.

The kF input port 113 is a port for receiving an air broadcast signal, which is generally connected to an antenna.

The line video/audio input port 115 is a port for receiving an analog signal mixed with a luminance signal Y and chrominance signals. Port 115 is used in connection with a camcorder, a DVD player, a settop box, and other devices, which provide analog video signals.

The digital audio output port 117 is a port for externally transmitting a digital audio signal provided from the main control part 160.

The tuner 121 tunes to a reception channel so that a broadcast signal on a channel requested from the input and output controller 125 controlled by the main control part 160 can be received through the RF input port 113.

The switching part 123 is controlled by the input/output controller 125 to selectively connect the input and output ports, which are connected to the switching part 123, to each other.

A video decoder 131 is controlled by the main control part 160 to decode and output a signal received through the super video input port 111 or the switching part 123.

An audio A/D converter 133 converts an analog audio signal input through the switching part 123 to a digital signal and outputs the digital signal to the MPEG encoder 141.

The MPEG encoder 141 is controlled by the main control part 160 to encode an audio signal output from the audio A/D converter 133 and a video signal output from the video decoder 131 in a known compression format, and stores to-be-stored data in the hard disk driver 151. Preferably, the MPEG encoder 141 carries out encoding based on the MPEG-2 compression format.

Reference number 143 denotes an SDRAM employed as a memory which will be used during the encoding process carried out in the MPEG encoder 141.

A data management part 157 manages the reproductions and records of data stored in the hard disk driver 151 and/or the disc player 155 (which is a recording media reproduction device). The data management part 157 is controlled by the main control part 160 to manage the storage of the data recorded in the disc player 155 into the hard disk driver 151, the storage of data stored in the hard disk driver 151 into the disc player 155, or the storage of the data encoded in the MPEG encoder 141 into the hard disk driver 151.

Disc player 155 is a component of the video recording/reproducing apparatus. The disc player 155 may be a DVD player for reproducing data stored in a recording media such as a digital video disk (DVD) and/or a compact disc (CD).

The disc player 155 can be connected to, and controlled by, the main control part 160, so as to perform recording/reproducing operations.

A light-receiving part 171 is a user interface which receives and outputs to the main control part 160, a user manipulation signal output from an external input device, such as the remote controller 200.

The main control part 160 processes the user manipulation signal received through the light-receiving part 171 and controls the respective parts of the apparatus.

The main control part 160 is formed of a single IC chip combining a central processing unit (CPU) 161 and an MPEG decoder 163. MPEG decoder 163 is used to decode signals compressed in the MPEG format. The MPEG decoder 163 may be provided as a separate and extra chip, and be connected to the main control part 160.

A flash memory 165 stores various programs related to the performance of the function of the main control part 160. The flash memory 165 is installed with a menu guide/process part 165a which is a program for carrying out a process of the recording media registration guide screen, which is described in detail below. SDRAM 167 is used by the main control part 161 for temporary storage space.

The audio D/A converter 135 converts a digital audio signal output from the MPEG decoder 163 of the main control part 160 into an analog audio signal, and outputs the analog audio signal to the switching part 123.

A video encoder 137 encodes a video signal output from the video decoder 131 and the MPEG decoder 163, and outputs the decoded video signal to the switching part 123.

The input/output controller 125 is controlled by the main control part 160 to control the tuner 121 and the switching part 123.

The main control part 160 in of video recording/reproducing apparatus 100 loads operating programs built in the flash memory 165 upon turning the power on and processes various support functions corresponding to signals received through the light-receiving part 171 from the remote controller 200.

The control process of the main control part 160 based on key selections from the remote controller will now be described in greater detail in connection with processing information from the recording media registration information guide screen.

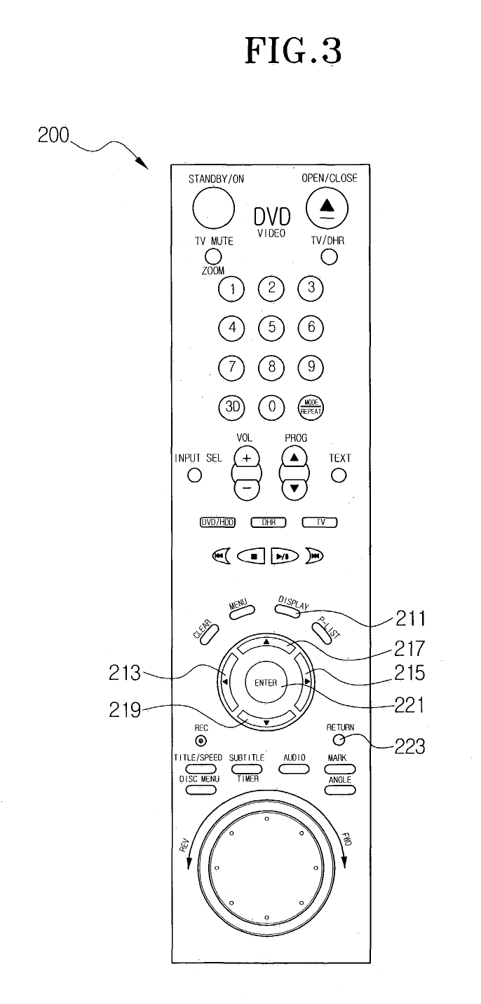

Referring now to FIG. 3, descriptions will be made regarding manipulations of a recording media registration information guide screen. In the recording media registration information guide screen the remote controller 200 is shown as an external input device for the video recording/reproducing apparatus 100 in accordance with an embodiment of the present invention.

Reference number 211 denotes a display key used when loading and closing a recording media registration information guide screen, and reference numbers 217, 219, 213 and 215 denote up, down, left, and right direction keys (respectively) employed for cursor movements with respect to classified items listed on the recording media registration information screen, described in greater detail below. Enter key 221 is used when selecting menus, and return key 223 is used when returning a current screen to a previous screen.

The rest of the keys are well-known keys and specific keys for manipulating the video recording/reproducing apparatus 100 and the television set 300, the functions of which can be easily understood through letters indicated nearby corresponding keys. Detailed descriptions regarding the functions of the keys will be omitted as one skilled in the art of the invention can appreciate their function and use.

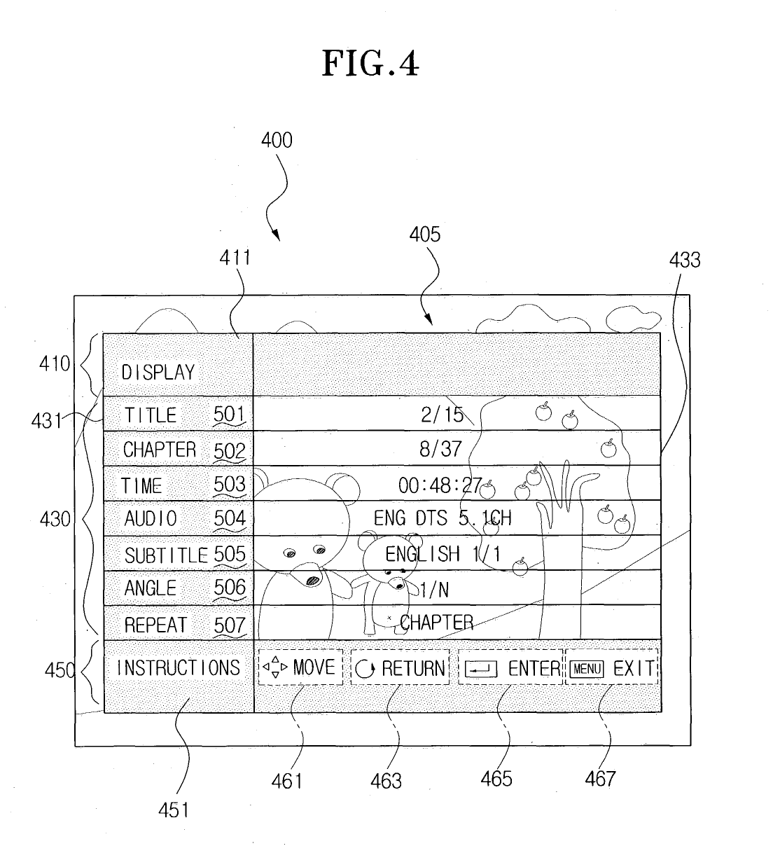

When the display key 211 of the remote controller 200 is selected, the main control part 160 launches a program of the menu guide/process part 165a to provide a recording media registration information guide screen to the television set 300 through the output port connected to the television 300 (e.g., line video/audio output port 116), and an illustrative recording media registration information guide screen is shown in FIG. 4.

Referring to FIG. 4, a recording media registration information guide screen 405 is horizontally divided into three areas: an upper area 410; a middle area 430; and a lower area 450.

The upper area 410 is vertically divided into two blocks. The indication of “DISPLAY” is placed in the left block 411 in correspondence to the recording media registration information guide screen 405.

The middle area 430 is also vertically divided into two blocks. A first block 431 is located on the left side, and a second block 433 is located on the right side.

The first block 431 of the middle area 430 has items classified in correspondence to registration information of a recording media. The second block 433 of the middle area 430 has recording media registration information corresponding to the classified items of first block 431.

The information shown in the first block 431 of the middle area 430 relates to registration information of a recording media such as a DVD, and is generally classified into the items shown in FIG. 4, discussed below.

An item “Title” 501 indicates the title of a movie or an animation stored in a DVD. The area showing information corresponding to the Title item 501 displays information regarding a title selected from a plurality of titles in the event that the DVD stores a plurality of movies or animations.

The item “Chapter” 502 indicates chapter information about DVD title shown in Title item 501. DVD titles can be divided into one or more chapters. Accordingly, the area showing information corresponding to the Chapter item 502 displays chapter information selected from the plurality of chapters in a selected title.

The item “Time” 503 indicates a DVD reproduction period of time. The area showing information corresponding to the Time item 503 displays information about the current reproduction period of time of a DVD reproduction period of time.

The item “Audio” 504 indicates the type of audio data for the plurality of titles recorded in a DVD. The area showing information corresponding to the Audio item 504 displays information on the Audio data type selected from a plurality of Audio data sets, which comprises diverse languages.

The item “Subtitle” 505 indicates caption data of movies or television broadcast terms. The area showing information corresponding to the Subtitle item 505 displays information corresponding to caption data currently being displayed with regard to diverse kinds of languages.

The item “Angle” 506 indicates angle information on about each chapter in a DVD. The area showing information corresponding to the Angle item 506 displays angle information on a selected angle from angle information obtained when photographing at various angles. In general, in a DVD, video data obtained from photographing one image with a camera at different directions or angles is recorded as angle data. Therefore, a user can view images photographed at a desired angle to his or her taste.

The item “Repeat” 507 is an item for setting a chapter or a title repeat mode. The area showing information corresponding to the Repeat item 507 displays information corresponding to a selected mode of the current chapter and title repeat modes.

In the meantime, displayed in the second block 433 of the middle area 430 is DVD registration information corresponding to the respective classified items listed in the first block 431.

As discussed above, when the display key 211 of the remote controller 200 is selected, the main control part 160 provides a recording media registration information guide screen 405 to a predetermined portion of the television set 300. The main control part 160 detects registration information recorded in a DVD inserted in the disc player 155 when a selection signal of the display key 211 is received through the light-receiving part 171 and provides the information through the DVD registration information guide screen 405.

In accordance with one embodiment of the invention, the main control part 160 processes the second block 433 of the middle area 430 to be semitransparent when the recording media registration information guide screen 405 is output on the screen 400 of the television set 300, so that the second block 433 is overlapped with an image displayed on the screen 400 of the television set 300. This allows block 433 and the image to be displayed together. Therefore, a user can view and check registration information recorded on a DVD, concurrently with the reproduced images displayed on the screen 400 of the television set 300 To accomplish concurrent viewing of a reproduced image and registration information from a DVD, the main control part 160 processes the first blocks 431 of the upper area 410, lower area 450, and middle area 430 to be opaque when the recording media registration information guide screen 405 is output, so that a user can conveniently manipulate keys. As shown in FIG. 4, dotted areas are used on the recording media registration information guide screen 405 to distinguish the opaque areas 410, 450, and 431 from transparent areas.

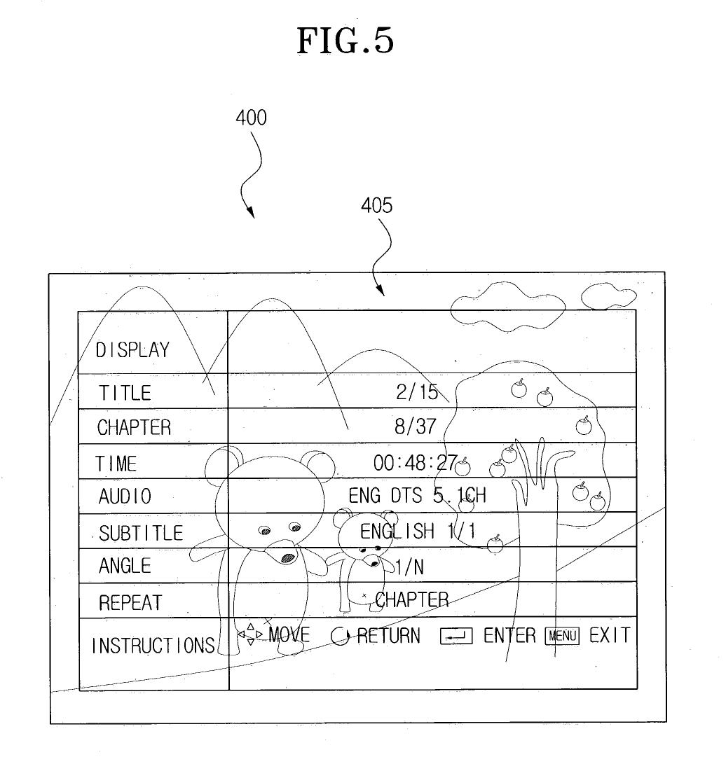

In the meantime, the main control part 160, as shown in FIG. 5, processes the entire recording media registration information guide screen 405 to be semitransparent so that the screen 405 can be overlapped and displayed together with an image currently displayed on the screen 400 of the television set 300. In this manner, a user can faster and more exactly check information on images being currently reproduced.

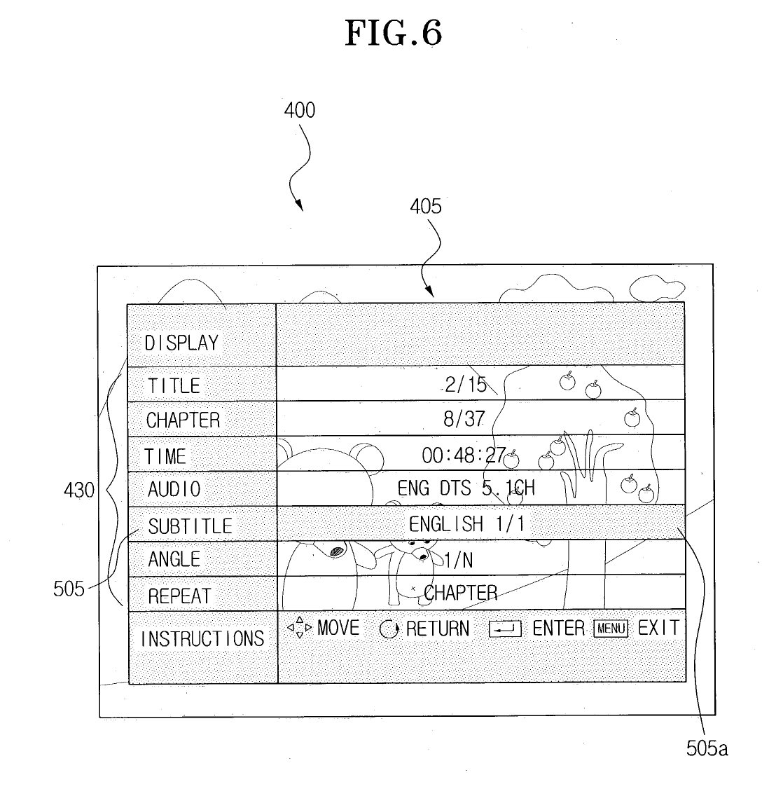

As shown in FIG. 4, in case that the recording media registration information guide screen 405 with the second blocks 433 processed semitransparent is output and a user selects the Subtitle item 505 out of the classified items displayed in the first blocks 431, as shown in FIG. 6, the main control part 160 outputs the opaque area 505a in which information corresponding to the Subtitle item 505 is displayed, so that the image on the area 505a is not seen. Further, the main control part 160 provides highlight-processed characters for a selected item.

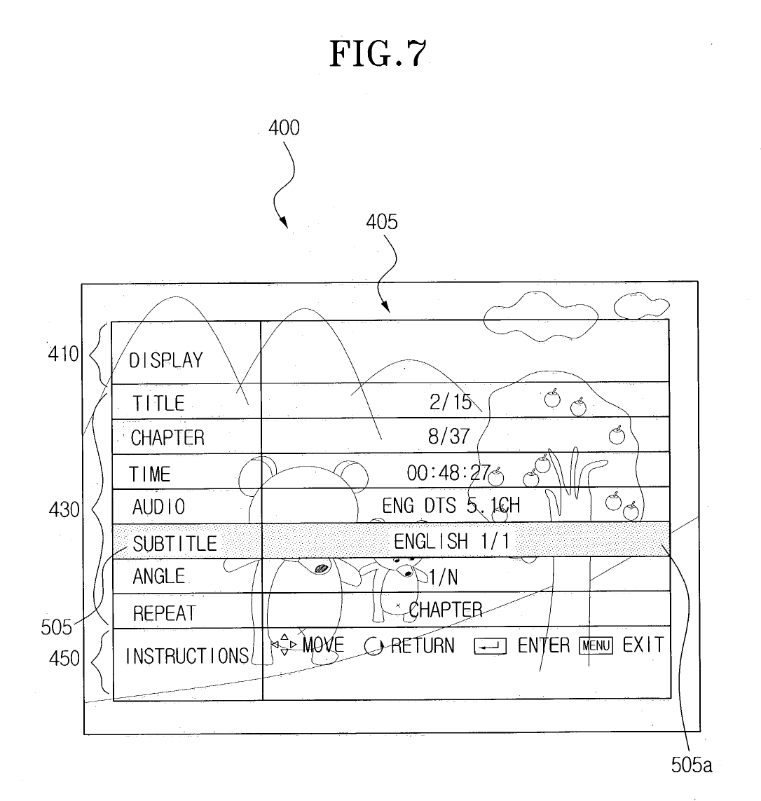

Meanwhile, as shown in FIG. 5, in case that the entire recording media registration information guide screen 405 is processed semitransparent and a user selects the Subtitle item 505 out of the classified items displayed in the first blocks 431, as shown in FIG. 7, the main control part 160 outputs the area in which the Subtitle item 505 is displayed and the area 505a in which information corresponding to the Subtitle item 505 is displayed to be opaque so that images in those areas are not seen.

The lower area 450 displays information on the manipulations and uses for the keys of the remote controller 200 in correspondence to the use of the recording media registration information guide screen 405. The lower area 450 has the word “Instructions” displayed in its first block 451 to guide the manipulations and uses of keys, wherein the first block 451 is divided to be vertically aligned with the first blocks 411 and 431 of the upper area 410 and the middle area 430, and the second block 453 on the right side of the first block 451 displays guide information corresponding to the keys provided on the remote controller 200 and their functions.

Referring to FIG. 4, the marks and guide information displayed on the lower area 450 are hereinafter referred to as “marks” in general, and identified as a cursor movement guide mark 461, a return guide mark 463, a selection guide mark 465, and an exit guide mark 467 to their functions.

The cursor movement guide mark 461 is used to move the cursor to the items selectively arranged in the middle area 430. The cursor movement guide mark 401 corresponds to the direction key marks corresponding to the direction keys 213, 215, 217, and 219 provided on the remote controller 200. The cursor generally refers to a display a user can perceive the movement from an item the cursor is currently positioned to a next item arranged at a position corresponding to a manipulation direction of the direction keys 213, 215, 217, and 219 when the direction keys 213,.215, 217, and 219 of the remote controller 200 are manipulated. The display can be implemented in diverse possible methods such as extra marks, highlight displays, shade displays, color change displays, and so on, for corresponding items.

The return guide mark 463 is used when a user wants to display a previous screen from a current screen. The return guide mark 463 corresponds to the return key 223 provided on the remote controller.

The selection guide mark 465 is used when an item on which the cursor is located is selected. The selection guide mark 465 corresponds to the enter key 221 provided on the remote controller 200.

The exit guide mark 467 is used when a user wants to change a display mode of the recording media registration information guide screen 405 to another mode. For example, a user can close the recording media registration information guide screen 405 through manipulation of exit guide mark 467.

Accordingly, a user can manipulate the up, down, left, and right direction keys 217, 219, 213, and 215 provided on the remote controller 200 when he or she wants to move the cursor to the items displayed in the middle area 430.

The information shown in the first blocks 431 of the upper area 410, middle area 430, and lower area 450 of the recording media registration information guide screen 405 as discussed above, is fixed information. Only the information displayed in the second block 433 of the middle area 430 is changed according to the registration information of each recording media.

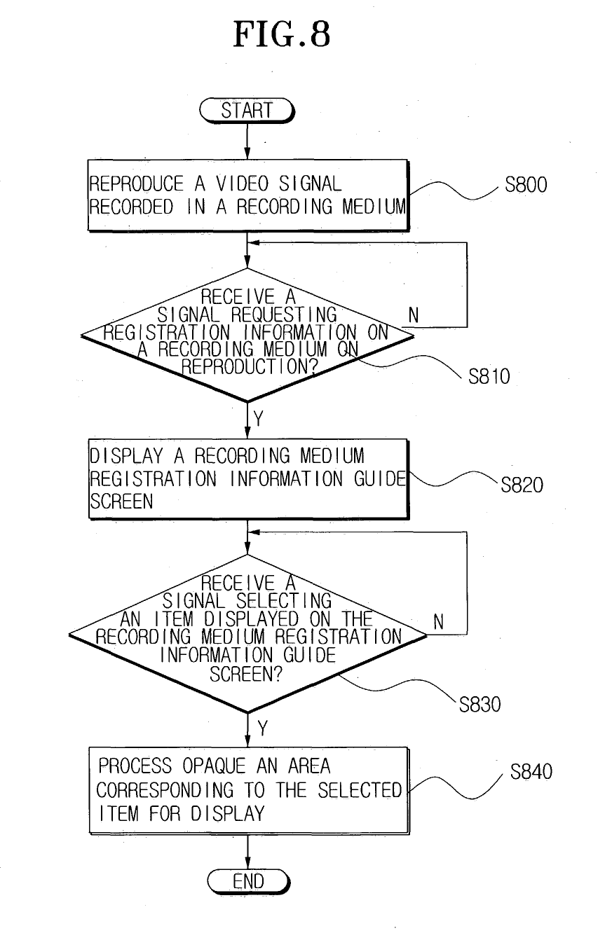

Hereinafter, a method for displaying recording media registration information for a video recording/reproducing apparatus according to an embodiment of the present invention is described with reference to FIG. 8.

If the main control part 160 receives a key signal for reproducing a recording media through the light-receiving part 171, the main control part 160 reproduces a video signal recorded in the recording media installed in the disc player 155 (step 800).

The main control part 160 decides whether a request signal'for the recording media registration information guide screen 405 is received from the remote controller 200 while displaying a video signal recorded in the recording media on the screen 400 of the television set 300 (step 810).

If it is decided that the request signal for the recording media registration information guide screen 405 is received as a result of the decision in the step 810 (“Yes” path from decision step 810), the main control part 160 provides the recording media registration information guide screen 405 onto the screen 400 of the television set 300 (step 820). At the same time, the main control part 160 processes an area displaying registration information of the recording media corresponding to an item classified on the recording media registration information guide screen 405 to be semitransparent, and overlaps the semitransparent area with the reproducing images to be displayed together.

The main control part 160 then decides whether a key signal corresponding to the selection of any one of the items classified on the recording media registration information guide screen 405 displayed on the screen 400 is received from the remote controller 200 (step 830).

If it is decided that any of the classified items is selected from the remote controller 200 as a result of the decision in the step 830 (“Yes” path from decision step 830), the main control part 160 processes an area corresponding to the selected item to be opaque, and displays the opaque area so that the reproducing images are not seen (step 840). At this time, the main control part 160 processes the letters belonging to the selected item to be highlighted for display. The main control part 160 processes the letters belonging to the item selected in correspondence to the opaquely processed area to be distinguished.

Thus far, a description has been provided of an embodiment of the invention utilizing a recording media such as a DVD, and the like, which provides registration information on images, but the display process as described above, can be also applied to broadcast signals providing information on images such as image titles, reproduction times, and so on.

The video recording/reproducing apparatus and the recording media registration information display method in accordance with the embodiments of the present invention can display, in a display format, registration information stored on a recording media, while the recorded images are reproduced, based on classified items, and emphasize a selected item of the classified items to make the selected item distinct. Further, another embodiment of the present invention enables a user to check the images from a recording media on reproduction while displaying registration information stored in the recording media, thereby enhancing the user's convenience.

While the invention has been shown and described with reference to certain embodiments thereof, it will be understood by those skilled in the art that various changes in form and details may be made therein without departing from the spirit and scope of the invention as defined by the appended claims.

1. A method for displaying registration information pertaining to recorded programs stored on a recording medium used in a video recording/reproducing apparatus, comprising:
receiving a request signal from an external access device requesting registration information pertaining to the recorded programs stored on the recording medium;
providing the requested registration information pertaining to the recorded programs stored on the recording medium to a screen associated with the video recording/reproducing apparatus; and
displaying the requested registration information on the screen associated with the video recording/reproducing apparatus in an area on the display, the area on the display being divided into a first and second area, wherein the first area displays classifications of registration information, and the second area displays registration information of the classification of registration information, the second area being semitransparent and overlapping a displayed video signal.

2. The method according to claim 1, wherein the first area is opaque.

3. The method according to claim 1, wherein the first area is semitransparent and overlaps a displayed video signal.

4. The method according to claim 1, further comprising:
selecting a classification of registration information displayed in the first area; and
displaying the registration information corresponding to the selected classification of registration information as an opaque portion in the second area.

5. The method according to claim 1, wherein the external access device is a remote control unit.

6. The method according to claim 1, wherein the first area of classifications of registration information comprises one or more classifications.

7. The method according to claim 6, wherein the one or more classifications comprises:
a first, second, third, fourth, fifth sixth and seventh items corresponding to the movie or animation stored in the stored on the recording medium used in a video recording/reproducing apparatus.

8. The method according to claim 7, wherein the first item comprises:
a title of a movie or animation stored on the recording medium used in a video recording/reproducing apparatus.

9. The method according to claim 7, wherein the second items comprises:
chapter information stored on the recording medium used in a video recording/reproducing apparatus which corresponds to the title information of the first item.

10. The method according to claim 7, wherein the third item comprises:
reproduction time of the recording medium used in a video recording/reproducing apparatus.

11. The method according to claim 7, wherein the fourth item comprises:
audio data which indicates the type of audio data for the plurality of title that can be stored on the recording medium used in a video recording/reproducing apparatus.

12. The method according to claim 7, wherein the fifth item comprises:
caption data stored on the recording medium used in a video recording/reproducing apparatus which corresponds to the title information of the first item.

13. The method according to claim 7, wherein the sixth item comprises:
angle information stored on the recording medium used in a video recording/reproducing apparatus which corresponds to the title information of the first item.

14. The method according to claim 7, wherein the seventh item comprises:
repeat mode information stored on the recording medium used in a video recording/reproducing apparatus which corresponds to the title information of the first item and the chapter information of the second item.

15. An apparatus for displaying registration information pertaining to recorded programs stored on a recording medium used in a video recording/reproducing apparatus, comprising:
an external access device to provide a request for registration information pertaining to the recorded programs stored on the recording medium to the video recording/reproducing apparatus;
a display associated with the video recording/reproducing apparatus to display requested registration information pertaining to the recorded programs stored on the recording medium, as well as recorded programs stored on the recording medium; and
an area on the display to display the requested registration information pertaining to the recorded programs stored on the recording medium, the area being divided into a first and second area, wherein the first area displays classifications of registration information, and the second area displays registration information of the classification of registration information, the second area being semitransparent and overlapping a displayed video signal.

16. The apparatus according to claim 15, wherein the first area is opaque.

17. The apparatus according to claim 15, wherein the first area is semitransparent and overlaps a displayed video signal.

18. The apparatus according to claim 15, wherein the area on the display to display the requested registration information pertaining to the recorded programs stored on the recording medium, further comprises:
the first area contains a classification of registration information that can be selected; and
the second area contains registration information corresponding to the selected classification of registration information as an opaque portion.

19. The apparatus according to claim 15, wherein the external access device is a remote control unit.

20. The apparatus according to claim 15, wherein the first area of classifications of registration information comprises one or more classifications.

21. The apparatus according to claim 20, wherein the one or more classifications comprises:
a first, second third, fourth, fifth sixth and seventh items corresponding to the movie or animation stored in the stored on the recording medium used in a video recording/reproducing apparatus.

22. The apparatus according to claim 21, wherein the first item comprises:
a title of a movie or animation stored on the recording medium used in a video recording/reproducing apparatus.

23. The apparatus according to claim 21, wherein the second items comprises:
chapter information stored on the recording medium used in a video recording/reproducing apparatus which corresponds to the title information of the first item.

24. The apparatus according to claim 21, wherein the third item comprises:..
reproduction time of the recording medium used in a video recording/reproducing apparatus.

25. The apparatus according to claim 21, wherein the fourth item comprises:
audio data which indicates the type of audio data for the plurality of title that can be stored on the recording medium used in a video recording/reproducing apparatus.

26. The apparatus according to claim 21, wherein the fifth item comprises:
caption data stored on the recording medium used in a video recording/reproducing apparatus which corresponds to the title information of the first item.

27. The apparatus according to claim 21, wherein the sixth item comprises:
angle information stored on the recording medium used in a video recording/reproducing apparatus which corresponds to the title information of the first item.

28. The apparatus according to claim 21, wherein the seventh item comprises:
repeat mode information stored on the recording medium used in a video recording/reproducing apparatus which corresponds to the title information of the first item and the chapter information of the second item.
